(19) United States
(12) Patent Application Publication
(10) Pub. No.: US 2008/0155478 A1
(43) Pub. Date: Jun. 26, 2008

(54) Virtual interface and system for controlling a device

(76) Inventor: Mark Stross, Pearland, TX (US)

Correspondence Address: Peter S. Canelias;Law Offices of Peter S. Canelias, Suite 2148, 420 Lexington Avenne, New York, NY, 10170, US

(21) Appl. No.: 11/643,529

(22) Filed: Dec. 21, 2006

(51) Int. Cl. G06F 3/048

(52) U.S. Cl. 715/849

(57) ABSTRACT

This invention relates to a system and method for operating and managing real world devices through a three-dimensional virtual user interface. In a preferred form, the invention relates to using a three-dimensional virtual user interface to control the playing of content items on a display device or on multiple display devices, all managed and operated by the present invention. The system allows for real-time previewing of the content items rendered on the displays on a single control computer monitor. The invention may be seen as a computer having an application employing a three-dimensional virtual user interface for operating and previewing a display device or devices.

### BACKGROUND OF THE INVENTION

1. Field of the Invention

This invention relates to a system and method for controlling and managing at least one device. The preferred implementation of this invention comprises a computer having a software application with a three-dimensional Virtual User Interface (VUI) for managing and controlling the rendering of content items to a display device or devices. These embodiments are particularly useful for operating signage displays in large arenas.

2. Description of Related Art

The advancement of display technologies has improved our ability to communicate information in a more effective and engaging way. High resolution in images and videos combined with relevant computer graphics allow for more enjoyable and contextual content. Incorporating live data feeds on a display device can provide an audience with real time information or statistical data regarding concurrent events and conditions. All of these content items can be strikingly attractive and entertaining when they are seamlessly integrated on the display devices.

The current technologies and systems available make that kind of seamless integration very difficult. Images, video, and statistics data may be stored in many different formats. Depending on the display device technology, content items may require conversion before being rendered on the display device. The wide array of media formats and the very specific requirements of display devices have unsurprisingly lead to a number of significant interoperability problems.

Interoperability problems force a display device operator to send video signals in a format that will be received by the video input of that display device and rendered correctly on the screen. These formats vary from vendor to vendor, even in the context of the same display technology. Although other variables are relevant, the format requirements of a display device may largely depend on the display size, resolution or number of pixels.

To avoid cropping and blurry rendering, images and video may be converted from one format to another. This may lead to a sacrifice in the quality of the content item and a waste of the processing resources. In general, there are many different ways to convert a content item. The solutions range from stand-alone conversion applications to small conversion scripts. There is no guarantee that these stand-alone tools will be able to convert every content item into a format that is displayable by every type of display device. In addition, new formats for content are constantly being developed, making it more difficult to choose a standard.

Interfaces for operating a display should enable a user to maximize the spatial, visual, and temporal capacities of a display. Today's applications fall significantly short of this goal. They are restricted by their design, a 2-dimensional window-based interface. These window-based interfaces are limited to the amount of information that may be conveyed to an operator by the size of the monitor. Attempts to expand their limits have lead to a multiple window interface and multi-frame applications. This results in “window thrashing,” in which the user must expend considerable effort to keep desired windows visible. An operator may never be able to gain a perspective on how the system is doing as a whole without “thrashing.” Operating a second or third display device is nearly impossible with these interfaces.

The current windows-based interfaces used applications fail in providing adequate usability, interactivity and scalability. Usability is defined herein as the capability of the interface to be understood, learned, used and attractive to the user. In windows-based graphical user interfaces (GUIs) an operator may easily have five separate windows, each addressing a particular function need of the system. The windows-based system fails because it requires an operator to toggle through windows to find the appropriate GUI for a particular task. When a number of windows are open, the desktop becomes very cluttered making it very difficult for the user to interact with the application efficiently. For the same reason, the multi-window design makes it impossible to scale.

U.S. Pat. No. 6,819,303 to Berger et al. discloses a method for sending a plurality of different signals to a large electronic sign. It does not provide real-time video preview and control of what is being played on the display devices. Thus, when the location of a physical display device is not within the operator's view, there is no way for the operator to monitor the performance of that display. The present invention, however, provides a three-dimensional VUI for managing and controlling multiple displays on a network. Because of the unique architecture, the present invention allows the operator to have a live preview of what is being played on the display devices no matter what tasks are being performed.

It is an object of this invention to provide a VUI for operating a real-world device. It is also an object of this invention to provide a method for converting any content item into a format that is ready for a wide variety of display devices technologies. It is another object of this invention to maintain the high-resolution and quality of the content items. It is an object of this invention to enable a single operator to manage several different display devices. It is another object of the invention to provide for remote connectivity. Another object of the invention is providing an operator with a visually intuitive, 3-Dimensional virtual user interface for operating a plurality of display devices. Other objects of the invention will become apparent in the following specification and drawings.

### BRIEF SUMMARY OF THE INVENTION

The present invention provides a novel system and method of operating a number of real-world devices. In its preferred form, the invention provides a three-dimensional VUI for operation and previewing of multiple displays. First, a radical change in the hardware architecture allocates graphics processing operations to a graphics processing unit (GPU) and other networked hardware. Offloading the rendering of content and the video output path to Sub-Servers frees up the resources of a Main Server.

There is no compromise to image or video quality. In accordance with the invention, a dedicated GPU processes images using 3D acceleration to composite and render multiple layers, as opposed to strips in the older technologies. With the content items organized by the resolution length (or size) of the target display, the Sub-Servers can render the content items to their target display devices more efficiently.

With the graphics intensive processing operations distributed among hardware devices, an operator may take advantage of the adaptive and modular software design. The distributive flexibility of hardware and software across a network enables a number of users and applications to collaborate in the same virtual environment. Departing from the restrictive windows-based interface model, the current invention provides a seamless, real-time representation of display devices and the tools necessary to operate them.

A VUI gives an operator the advantage of managing pooled resources across the network, allowing them to be more responsive to dynamic needs and to better leverage entire infrastructure. The immersive 3-dimensional environment is capable of simultaneously presenting a graphical representation of every resource an operator may need. In a single environment, the VUI allows an operator to manage and control multiple display devices.

A VUI provides superior usability, enhanced user interaction and scalability. Usability is improved because the VUI gives an operator the freedom to move interface objects along the x, y as well as z-axis. The VUI makes learning an interface easier because it affords an operator broad latitude for display customizations, system configurations and plug-in possibilities. Scalability is a non-issue because is there is no limit to the number of display devices that can be managed. Even when the types of display technologies are different, the present invention gives the operator a fully dynamic three-dimensional representation of all the display devices on the network. With this approach, an operator may monitor and control playback on all of the display devices at the same time.

The invention is described below, with reference to detailed illustrated embodiments. It will be apparent that the invention can be embodied in a wide variety of forms, some of which may be different from those of the disclosed embodiments. Consequently, the specific structural and functional details disclosed herein are only representative and do not limit the scope of the invention. The following description sets forth, among other things, implementations of various technologies and techniques that may be used in, or in conjunction with a VUI for managing and controlling the operation of one or more display devices.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is a block diagram showing an overview of the system;

FIG. 2a is a block diagram showing a display device having a video input and output, the display device has three different resolution sizes, full resolution, resolution B, and resolution C;

FIG. 2b is a block diagram showing a display device having a video input and a video board processor, the display device broken up into four different segments;

FIG. 3 is a schematic diagram showing an arrangement of multiple display devices;

FIG. 4 is a schematic diagram showing exemplary hardware for implementing the system;

FIG. 5 is a schematic diagram showing a first embodiment of a network configuration;

FIG. 6 is a schematic diagram showing a second embodiment of a network configuration;

FIG. 7 is a schematic diagram showing a third embodiment of a network configuration;

FIG. 8 is a schematic diagram showing the grid algorithm for processing graphics;

FIG. 9 is a flowchart showing operator steps;

FIG. 10 is a first screenshot of the three-dimensional virtual user interface;

FIG. 11 is a second screenshot of the three-dimensional virtual user interface.

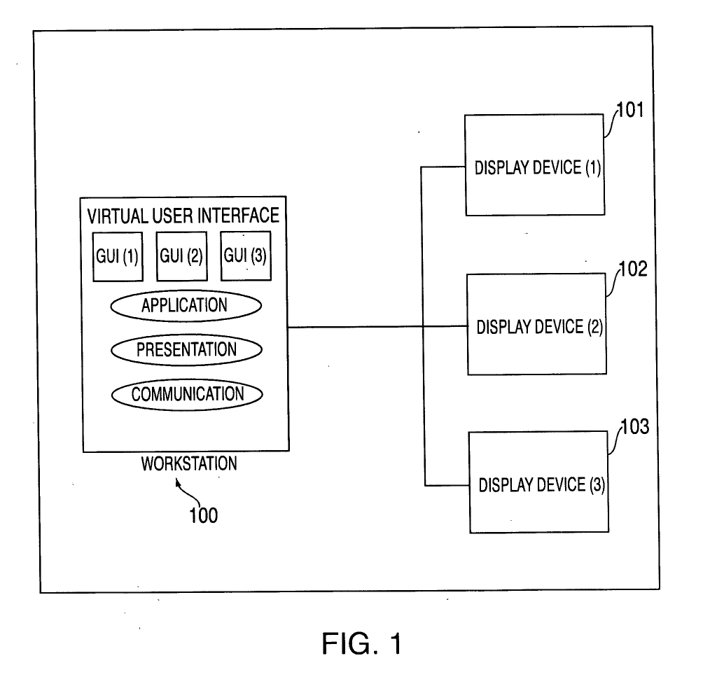

### DETAILED DESCRIPTION

Briefly, the systems and methods of the present invention pertain to operating at least one display device with a greater degree of efficiency and without sacrificing the quality in rendering content items. In this regard, a more efficient, visually intuitive operating experience is given effect by enabling a novel system to present a customizable set of interface objects for adjusting or adding to the functionality of the invention. The novel system supports these tasks by providing a 3-dimensional VUI that supports converting content items, storing content items, managing content items, composing a queue of content items, managing multiple displays, processing graphics, supporting layers, creating batches, editing batches, and other related tasks.

In particular, the VUI, to be described in greater detail below, may take the form a stand-alone software application. A VUI is presented to an operator as an immersive, 3-Dimensional environment having a plurality of interface objects available within a single interface. In some embodiments, an interface object may take the form of a window instance, a frame, a sidebar, or any other windows-based interface standard. In other embodiments, interface objects may take the form of interface tools. For example, interface objects may include navigation tools, menu bar tools, toolbars, trashcans and the like. Still other embodiments may have interface objects that take the form of data visualization tools, including graphs, trees, node-link diagrams, maps, treemaps, network diagrams and the like. Without limitation, other interface object types that will be apparent to those having skill in the art may be used in accordance with the present invention.

It is sufficient to note that the VUI, according to the invention, is so implemented and is intended to function as an application in connection with the a display device such as an LCD, LED, Plasma, Video Screen, HD, and the like. As to display devices, many different devices may be used and the application may be upgraded or hardware may be added so that the input of the particular display device correctly receives and renders the video output of the application.

For operating non-display devices, the device receives an input signal activating or triggering the device.

A display device may be generally understood to have a frame size, a frame shape, an image quality metric, a pixel pitch, a video input and a video output. The frame size refers to the area of the screen. For some displays this may be indicated by pixel aspect ratio, or pixel by pixel. In one embodiment, the frame size is 772×702 pixels, taking the shape of a flat rectangle and has a pixel count of approximately 600,000. In other embodiments, especially with different display technologies, a frame size may be defined differently.

In accordance with the present invention, the frame size may be relatively large and are generally used for events with large audiences in arenas, stadiums, convention centers, and the like. To be clear, the display devices are not required to be indoor, they may also be used and controlled outdoors as well. The frame shape may be embodied singly or in combination as a rotational display, press box display, banner, flat square display, or flat rectangular display. Without limitation, any of the display devices may be modular. In other words, a single display device may be a combination of a number of display devices working together to render content items. Display devices may also be portable, mountable, and configurable.

An image quality metric refers to the quality of the video output for a particular display device. This may be denoted by a pixel count or resolution, but again the image quality metric may depend on the type display technology or standard being used. For example, a pixel pitch is a specification for a display device that describes the distance between phosphor dots or LCD cells of the same color on the inside of a display screen. Calculated in millimeters, pixel pitch is a measure of the size of a triad plus the distance between the triads. Generally speaking, a smaller number generally means a sharper image.

Video input and output devices are the physical components that permit signals to be transmitted to a display device and rendered on the screen. Video input devices generally receive content items conforming to the specifications of a display device. If the content is not processed according to the specifications of the display device, the video input device will render the content that is too small, too big, blurry, stuttering, or compromised in some other way.

Other attributes of various display devices should be apparent to those having skill in the art and need not be discussed with any greater detail. Examples of some display devices used in accordance with the invention include the ANC standard rotational unit, the SmartVision Pro 15 mm, and the Lighthouse 25 mm Suite One Fascia. Again, the present invention is highly adaptable and may be updated with software or hardware to function in connection with any real-world device.

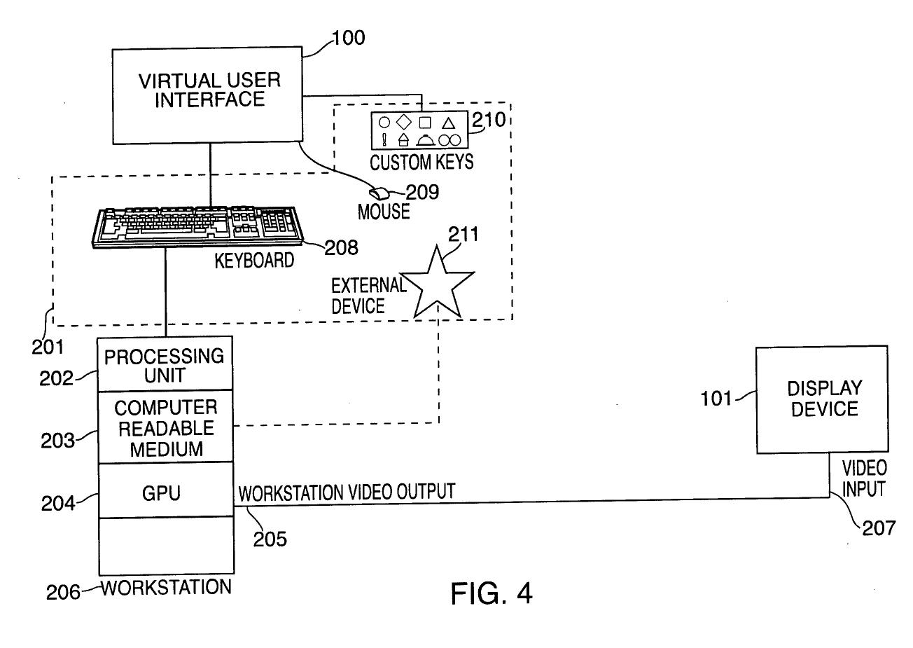

In the exemplary embodiment of FIG. 4, the hardware that is needed to implement such a system can be seen as comprising a workstation 101 having a monitor 100 on which a VUI is presented, an input device 201, a computer readable medium 203, a central processing unit 202, a GPU 204, and display device 101. The workstation CPU 202 may be implemented on a single chip, multiple chips or multiple electrical components. One embodiment may have a Dual Intel Xeon system running at 3.0 GHz with an 800 MHz front-side bus for increased throughput and image continuity. Other embodiments may have multiple processors.

A computer readable medium 203 may be a magnetic hard disk, an optical disk, a floppy disk, CD-ROM (Compact Disk Read-Only Memory), RAM (Random Access Memory), ROM (Read-Only Memory), FLASH, Electrically Erasable Programmable Read-Only Memory (“EEPROM”), or other readable or writeable data storage technology, singly or in combination. In one embodiment, the computer readable medium comprises 2 Gigs DDR RAM, a 40 GB Ultra-SCSI hard drive, a 240+GB Ultra-SCSI video storage drive for rapid access to stored content items, a plurality of 256 DirectX Capable Video cards, IEEE Firewire input/output ports, USB 2.0 input/output ports, CD-R/DVD-R combination media burner. The workstation is preferably running Microsoft Windows XP Professional operating system for stability and 3rd party software compatibility. Other operating systems, including later versions of Windows such as Microsoft Vista, can be used as well.

The workstation monitor 100 presents the VUI to an operator, permitting the operator to manage and control the display device 101 or devices by interacting with the VUI. A workstation monitor may either be physically integrated with the workstation or physically separate. In one embodiment, the monitor is a 21″ Panasonic LCD. In addition to the virtual user interface, a workstation may have a virtual desktop application installed, creating more workspaces on a single monitor, but this is not requirement. Other embodiments may have a plurality of monitors for a multi-monitor desktop workspace. A workstation monitor may also include mechanisms, such as touch screen technology, a stylus sensor, a sensor for operator authentication, voice recognition technology, or the like, through which an operator may interact with the VUI.

The workstation input device 201 allows an operator to interact with objects within the VUI presented on workstation monitor. In the preferred embodiment, the input device includes a keyboard 208 and a mouse 209. Other embodiments may include a plurality of input devices that facilitate interaction between the operator and the VUI. The workstation keyboard may be physical or virtual; the physical keyboard may also have a set of customized keys 210. A virtual keyboard may have a set of predetermined or customizable virtual keys to assist the operator in navigating through the VUI.

In addition to the keyboard and mouse, the input device may include, or be operably connected to; other input devices (e.g. camera, microphone, etc.) and output devices (e.g. speakers, printers, and other peripherals, etc.). An example would be a device 211 that integrates a remote ability for a building's lighting controller to activate the functions of the invention on a “lights on” or “lights off” signal. The specialized input device 211 may be implemented as a circuit that takes a “dry pair” signal from the lighting controller and translates the signal to keyboard input which is sent to the system triggering actions. Incorporating a specialized input device to activate the functions provides a mechanism for the VUI to operate and control other real-world devices. The specialized input device 211 may also trigger a automatic doors, alarms, energy supplies, and the like.

Concerning display devices, as understood by those having ordinary skill in the art the GPU 204 may also be referred to as a video card, a graphics accelerator card, or a display adapter. In general, the GPU 204 is a piece of computer hardware that functions to generate and output images to a display. In the preferred embodiment, the GPU is a DirectX capable NVidia graphics card with 256 MB of Video RAM (VRAM). In other embodiments, the GPU 204 may include a plurality of graphics cards from different manufacturers; these cards may be capable of processing a variety video output formats and/or have more VRAM.

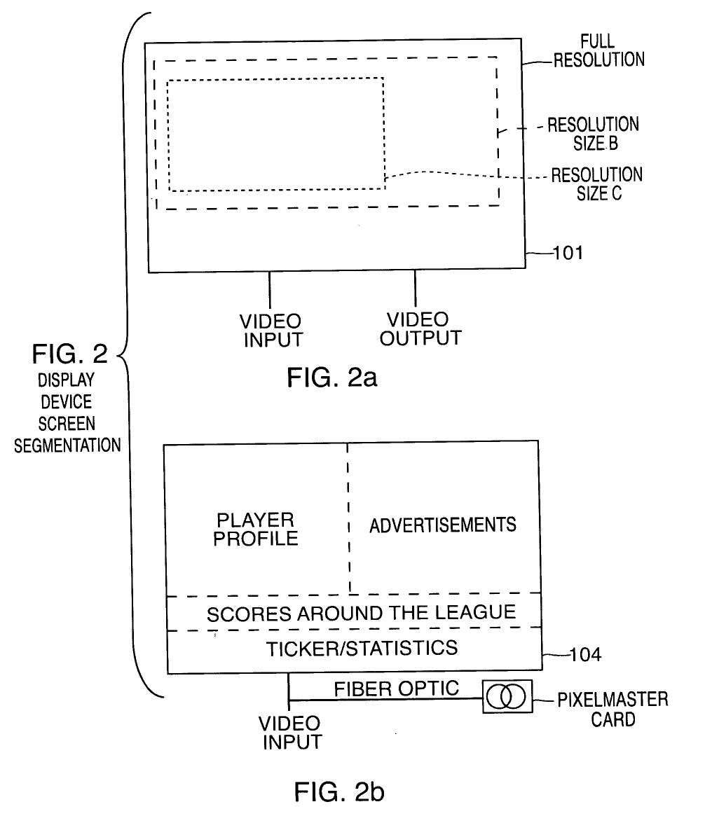

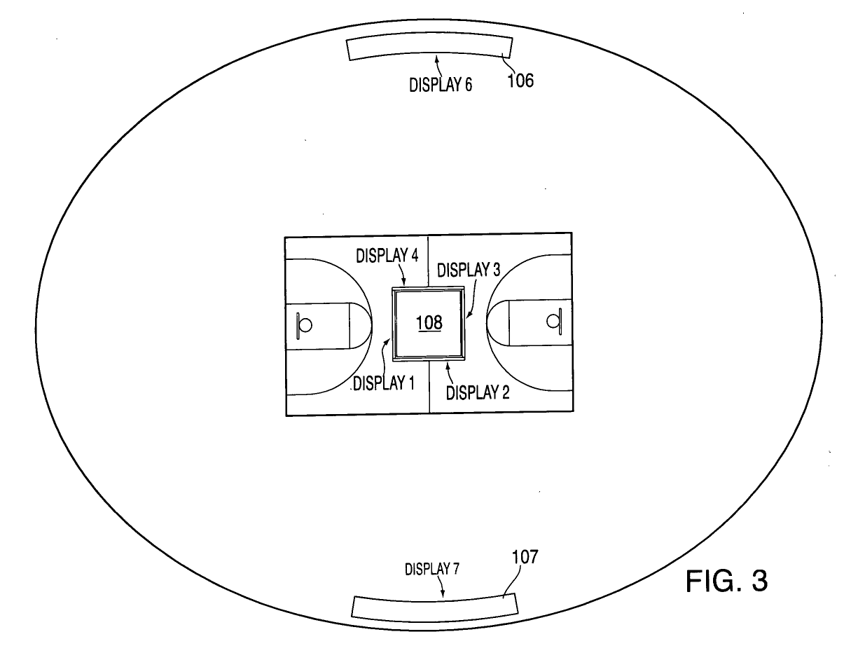

The GPU 204 is responsible for all graphic data manipulation. In general, the GPU 204 serves two main functions. First, the GPU 204 handles the graphics for presenting a three-dimensional virtual user interface to an operator's monitor 100. Second, the GPU 204 is responsible for processing the content items that are sent to the display devicelsl or devices as shown in FIG. 2. For the display devices, the GPU 204 may handle timing, scaling, and image sizing, leaving the final aspect ratio and screen array choices to the operator. When the GPU 204 is ready to send a content item to a display device 100, the display device may receive the content item with its own screen processor 105, as shown in FIG. 2.

A display device's video board processor 105 largely depends on the display technology. In one embodiment, the SmartVision 15 mm display device uses the SACO processor to receive the content items sent by the GPU 204. The SACO processor is preferably connected to the GPU 204 via fiber optic cable, although other means of connectivity are available. In other embodiments, the GPU 204 maybe anywhere on a wired or wireless network as long as it is in communication with the workstation and display device via Ethernet, USB, FireWire, fiber optic, WAP, WiFi or the like. The display device screen processors currently available include the Toaster SDI Daughter Card, the SACO DVI-SE processor, and the PixelMaster DVI processor. Additional hardware may also be required for some systems. For example, HD-SDI cards may be used to capture High-Definition signals. Barco/Folsom Encore systems may also provide the additional hardware support for HD systems.

### Exemplary Network Configuration

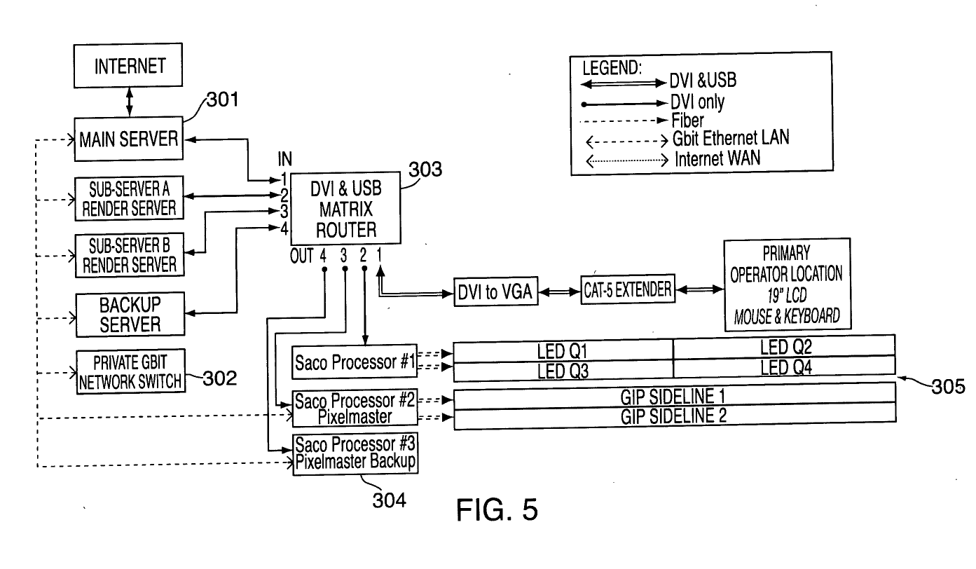

It will be apparent to those having skill in the art that the hardware required may be configured in a networked environment. The particular configuration may depend on the number and size of displays, the place, and the hardware available. While a wide variety of network configurations are available, the preferred embodiment follows a Main Server/Sub-Server model. Those having skill in the art may recognize the Main Server/Sub-Server architecture as a Master/Slave or Client/Server network structure. As shown in FIG. 5, the Main Server/Sub-Server embodiment is one example of how the different hardware devices may be distributed on a network.

The Main Server supports the VUI. The Main Server may control multiple display devices from the interface by sending commands to a Sub-Server. The Main Server may have a CPU, input device, network link for communication with the Sub-Server(s). In the preferred embodiment, all servers have 250 GB SATA RAID 1 Boot drives, Triple-redundant 780 W power supplies, and a backup image of the operating system. Preferably, Sub-Servers additionally have an expandable 410 GB 10 KRPM SCSI RAID 5 hard drive with Hot-Spare for content storage. In addition, the Main Server is preferably connected to a plurality of Sub-Servers. One type of Sub-Server that may be included on the network is a Statistics-Server. The Statistics-Server may be a database or other data source that stores statistics data including sports scores, weather data, lottery results and the like.

All servers on the system are preferably connected via a private Gigabit Ethernet. A Backup Server may be used as a failsafe Sub-Server in case the Statistics Server or a Render Server goes down. The Render Server, another type of Sub-Server, may be used for storing content items and sending them to a display device. A Render Server, sometimes referred to as a slave server, may have a high performance video card, network link, and a computer readable medium for data storage. The Render Server runs the Render Engine, a software module for processing graphics sent to a display device.

Given that many display devices differ in resolution, size, and shape; they may require their own separate Render Engine. Each Render Engine may then store and generate the content items for its display device. Without limitation, a single Render Server may run multiple Render Engines connected to multiple displays. The Render Server is limited only by available processing, memory, data storage and memory resources.

The Main and Sub-Servers may be tied together over the Data Transport Protocols by establishing bi-directional connectivity and synchronization between the Main Server and each Sub-Server on the network. Without limitations, other protocols may be used to connect the Main and Sub-Servers. Upon connection between the Main Server and a Sub-Server, a real-time preview data stream is established, followed by an accounting of all the content items for each display device.

With this connectivity in place, commands from the Main Server may be sent to a Render Engine for performing various graphics intensive tasks, e.g. display content, render character generated elements, transition content, and add visual effects through computer graphics. A Main Server may send instructions to a single, all, or a combination of Render Engines. In addition, a Main Server may also synchronize with another Main Server-via the Intercom mechanism.

The Intercom mechanism is comprised of a Client/Server architecture where each Main Server establishes an Intercom Server as well as attempts to connect to other Intercom Servers as a client. This facilitates a bi-directional communication path amongst all suitably configured Main Servers. The Intercom protocol is a simple command set that instructs listening Main Servers to activate a specific batch script using a unique keyword system. For example, two Main Servers, denoted as Main-A and Main-B, control eight video display devices via three Render Servers. A batch script configured on both Main Servers with a keyword of “Goal” correspondingly triggers the Goal animation for all attached display devices. When Main-A's Goal batch script is triggered, a data packet is sent to Main-B's Intercom server with the message “Goal.” Main-B receives and decodes the packet, determines that it has a batch script with the keyword of “Goal” and activates said batch, which then instructs each Render Server to transmit the Goal animation in synchronized unison.

The networked structure of the present invention also permits the Main Server to control other physical real-world items; it is not limited to the operation of display devices. For example, stage lights, water canons, or fireworks may be controlled and synchronized by the Main Server. If, at any point, the connection to a Render Server fails, the preview module in the VUI will reflect the problem by changing color, or otherwise alerting the operator that there is a connectivity issue. The failure of one Sub-Server does not affect the performance other Sub-Servers. While the system is running, an operator may reboot the failed Render Server, correct and log the errors for debugging.

The Main Server/Sub-Server architecture achieves a more reliable and capable system. As mentioned above, there are redundancy and failsafe technologies in place. With the appropriate hardware, there is no limit to the number display devices, screens, resolution sizes or pixels the system can handle. In addition, there is no requirement that any of the previously mentioned components be homogenous. In other words, the display devices or screens may encompass a broad range of display technologies, come from different manufactures and have distinct requirements for video input, and may be combined with non-display devices.

### First Embodiment of Network Architecture

Turning now to FIG. 5, we see one example of how an embodiment of the invention may be configured on a network. In FIG. 5, the system's hardware devices are distributed across one Main Server 301, three Sub-Servers, and a network switch 302 and connected via Gigabit Ethernet. The system hardware sends a video signal to a router 303 that sends the signal to the video input 304 (processors) of the display devices 305. In the embodiment of FIG. 5, there are two display devices, an LED and a GIP Sideline display. The LED is broken up into four quadrants while the GIP Sideline display is broken up into two strips. FIG. 5 also shows a primary operator location having a monitor, mouse and keyboard. All of the hardware in FIG. 5 is operably connected to the network via DVI, DVI and USB, fiber optic cable, GBit Ethernet, or wireless internet (WAN).

### Second Embodiment of Network Architecture

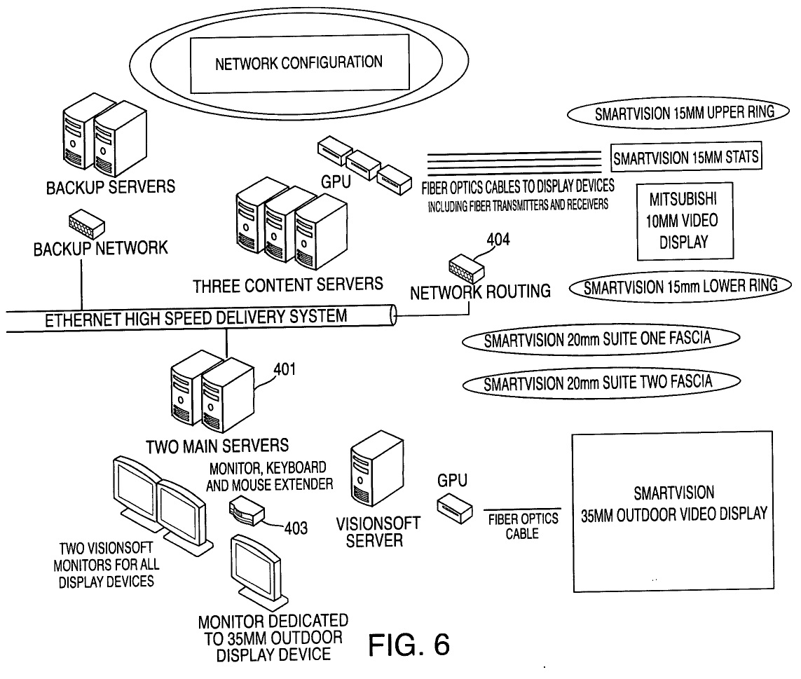

Turning now to FIG. 6, we see a second example of how an embodiment of the invention may be configured on a network. In FIG. 6, the hardware is distributed across two Main Servers 401 having three monitors 402, keyboard 403 and mouse extender 403. The two Main Servers 401 are connected via Ethernet and router 404 to three Content (Render) servers, a VisionSoft (Main) server, a Statistics Server, and two Backup servers. The three Content (Render) Servers have their own GPUs and are connected to six medium sized display devices. The medium display devices include the SmartVision 15 mm Upper Ring, SmartVision 15 mm Stats, Mitsubishi 10 mm Video Display, SmartVision 15 mm Lower Ring, a first SmartVision 20 mm suite fascia, and a second SmartVision 20 mm suite one fascia. The VisionSoft (Main) Server has a GPU and is connected to a large display, the SmartVision outdoor video display. The Main server uses two monitors for controlling and managing the six medium displays and another monitor for solely the 35 mm display. It should be apparent to those having skill in the art that there exist a number of permutations with respect how the hardware is distributed on the network.

### Third Embodiment of Network Architecture

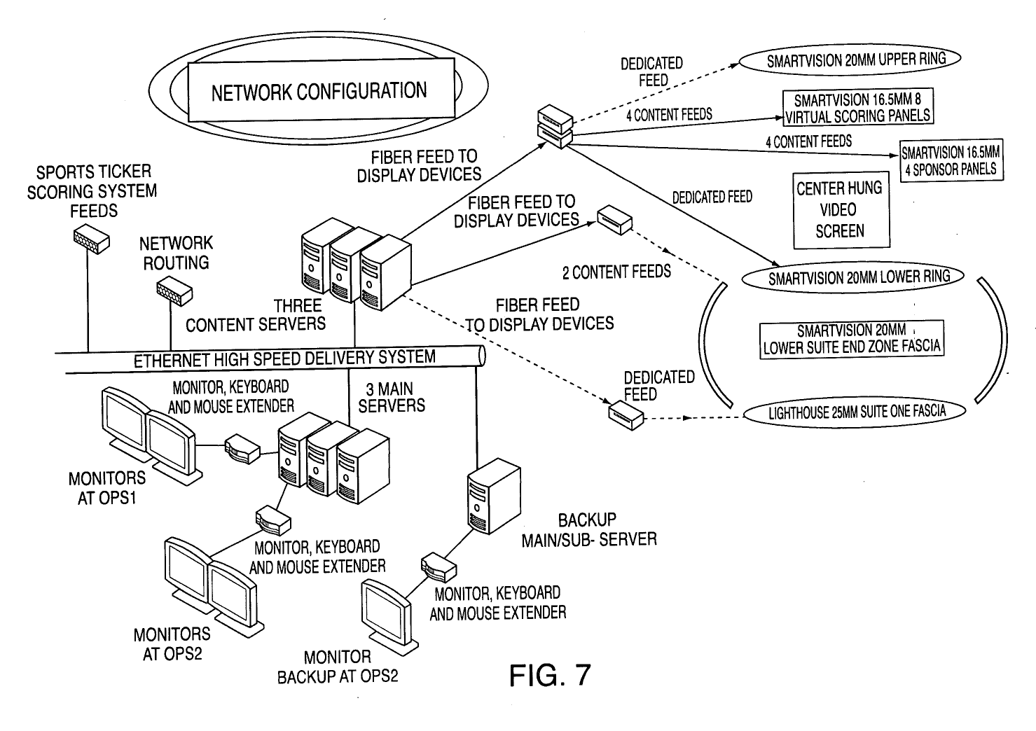

Turning now to FIG. 7, we see yet another example of how an embodiment of the invention may be configured on a network. In FIG. 7, the hardware is distributed across three Main Servers having four monitors and two sets of input devices. The three Main Servers are connected via Ethernet and router to a Backup Server, Main Server workstation, having a monitor and input device, three Content (Render) Servers, and a sports ticker scoring system feed (Statistics Server). The three Content (Render) Servers are connected to four display devices processors via a fiber optic link. As shown in FIG. 7, the GPUs may transmit content items to the seven display devices via a dedicated feed, a plurality of content feeds, or both. The SmartVision 20 mm Upper Ring display receives a dedicated feed. A first and second SmartVision16.5 mm display device, which can provide 8 virtual scoring panels, receive a total of 8 content feeds, 4 content feeds a piece. A center hung video screen being in communication with the content servers. The SmartVision 20 mm Lower Ring receives a dedicated feed. The SmartVision 20 mm Lower Suite End Zone Fascia receives two content feeds. Finally, a dedicated feed sends content items to the Lighthouse 25 mm suite one fascia.

As shown in FIGS. 5-7, the various hardware devices are connected through a combination of Ethernet, fiber optic, USB, Firewire cables, and DVI. Without limitation, the network configuration may facilitate wireless or wire-based communication with other computers, computer networks, mobile devices, peripherals, and other similar devices. The various servers and devices on the network may communicate over any IP enabled infrastructure. They may do so by using a custom command protocol. In one embodiment, Virtual Network Computing (VNC) is used to establish a secure and remote connection among many computers. Given the networked structure of the system in accordance with the invention, it will be appreciated by those having skill in the art, that the various hardware components might be distributed over a number of computing devices.

### Software Architecture

It is logical now to appreciate how the software architecture may mirror the distributive flexibility of the hardware architecture. Like the hardware architecture, the software design is modular. In other words, the functional modules may run or be accessed from the Main Server, a Sub-Server, or even a remote computer. This flexibility permits a plurality of operators to collaborate on the control and management of multiple display device systems. It will be further appreciated that as the hardware components are further distributed across a network, more operators may interact with the system through a thin client application. As the hardware components are pulled together, fewer operators may interact with the system through a thick client application. The system itself may now be viewed as a software application comprising three separate functional layers, a model application layer, a presentation layer and a communication layer.

### Communication Layer

The communication layer functions to establish connections among various software modules, permitting the modules to send messages to each other. As mentioned above, VNC may be used as a means of connecting the functional modules. It will be apparent to those having skill in the art that there exist a number of means, open as well as secure, for establishing a connection. Some functionality, e.g. (activate, change loops, and schedule the activation of the system), may even be done remotely via the Internet by tunneling. The remote communication module may also work on a variety of Internet Protocol (IP) enabled hardware devices. For example, cell phones with Internet connectivity may access the system from virtually anywhere. Again, the various communications means should be apparent to those having skill in the art and will not be discussed in greater detail.

### Application Layer

To fully appreciate the novelty of this invention it is important to outline the functional responsibilities of the application layer. The application layer contains the functional modules that permit an operator or operators to manage and control the components of the system. The following embodiments are presented as an example of some of the functionality and should not be read to limit the present invention. Indeed, the modular and adaptive software design permits the addition of many more functional modules. In a preferred application layer, there is a media module, a composition module, image processing module, a batch module, and a set of miscellaneous functional modules.

The media module is responsible for adding, converting, storing, categorizing, moving, and altering media or content items. The media module converts images, animation, video into a format that may be sent to a display device. When the conversion is complete, the media may be stored onto a computer readable medium, for example, the hard drive of one of the Render Servers (Sub-Server) in FIG. 5. The media files may be organized into categories or folders. In one embodiment the default categories may include miscellaneous, advertisements, and prompts. The folders may further delineate the media files by size or resolution. Delineating by size or resolution can prove helpful when dealing with multiple displays having specific size and resolution requirements.

A unique aspect of the invention is that an operator may add or remove content items at will. More specifically, new media files may be added for immediate transmission to a display device while the application is running. After new media is converted into the proper format and stored, the media manager may rescan the folders for a new content item. The media module may recognize the new content item by making it available to the operator by presenting it on the three-dimensional VUI. When a media item is made available, the operator may employ the functionality of the composition module.

The composition module is responsible for staging, preparing, error-checking, ordering, and sending content items to a display device. The composition module uses two queues to handle the order in which the display devices present a media files. The composition module may also designate the size of video output, preferably a pixel size. It is also responsible sending the input feed from a Statistics Server to the correct display device.

The composition module solves the significant problem of managing multiple displays through a process called “layering.” Layering is the process of placing multiple files of different output formats (pixel resolution, size, color, etc.) together to be displayed on different devices at the same time. Because the VUI presents the video outputs for multiple display screens on a single monitor, an operator may populate the setup queue for one video output of a display device and then populate the setup queue of a second video output for a second display device. It should be clear that when both of the setup queues are transferred to the live queue, they play simultaneously.

Uniquely, these layers may also be locked or unlocked. Locking a layer prohibits the operator from modifying the queue. In one embodiment, a setup queue and a video output for a display device are dedicated with advertisements from sponsors. The operator does not have to worry about continuously monitoring a display device in fear of a blank screen.

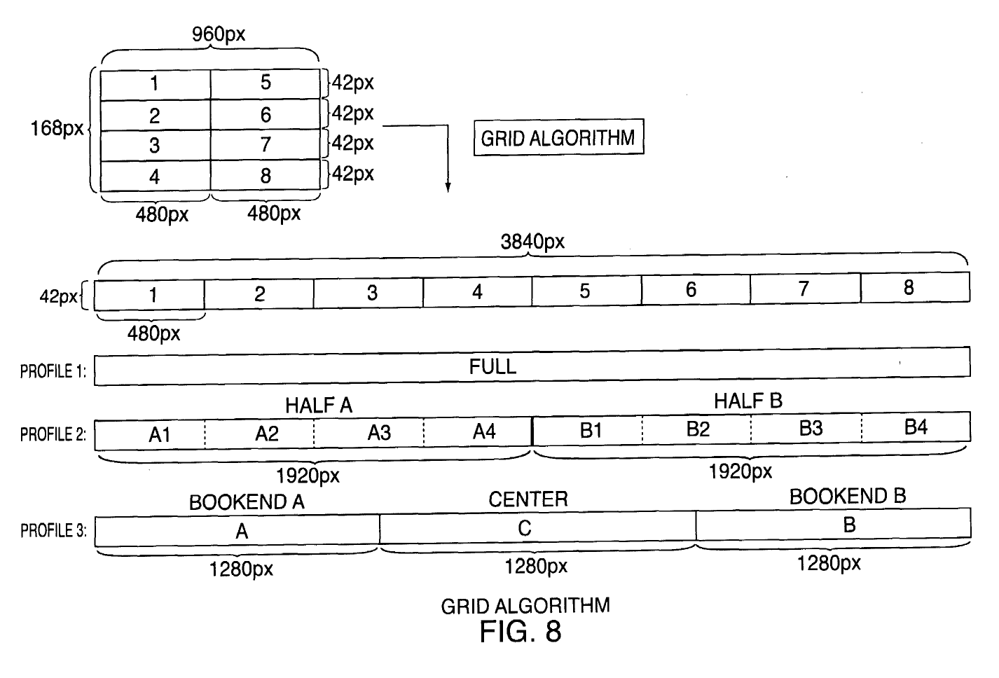

Turning now to FIG. 8, we see another unique aspect of the invention, the “Grid algorithm” for processing graphics. Without limitation, there are many graphics processing algorithms known in the art, the “Grid” algorithm is one preferred algorithm. For the purposes of describing the algorithm, a “fascia” will be understood to mean a long thin strip of video or image file. One embodiment of the algorithm requires the image (content item) to be stored on the system in strips, as a whole at the resolution of the target display device. For example, some content items may be stored in a 608 pixel folder, 1728 folder, 3184 pixel folder, or a 3792 pixel folder. In other embodiments, the number of folders and the pixel number associated with them depend on the number of display devices and their frame size.

In FIG. 8, we see the grid algorithm applied on a fascia strip (video/image file) having a resolution of 3840×42 pixels. The strip is divided into eight cells, each cell having a resolution of 480×42 pixels. The cells are then aligned end to end. Since the 3840×42 display size is an uncharacteristic size, the algorithm is unique because it cuts the file rendered in the full resolution of the fascia into the grid that can be processed by the exemplary hardware in real-time. This allows for “tiling”, rendering smaller content items on the display device. In addition, a display device may be subdivided into smaller, encapsulated segments.

An arrangement of segments may then serve as a display profile. For example, a full profile may have a 3840 pixel display. A half and half profile may have two 1920 pixel displays. A bookend profile may have a center segment of 1920 pixels and two bookend segments each having 960 pixels. It should be clear that the permutations for the arrangement of segments are endless.

By employing strip segmentation, the grid algorithm yields some unique benefits. Some of those benefits include a real time preview within the VUI showing the operator what is playing. In addition, layering allows dynamic effects like scrolling text and more efficient data transfer of smaller, encapsulated content items. These benefits make the intense task of graphics processing much easier, giving an operator the freedom to employ some of the miscellaneous functions in the application.

Continuing with the application layer, the set of miscellaneous functional modules may include a plug-in module, a third-party software module, a third-party hardware module, a customization module, a system configuration module, a playback module, and a batch module. To be clear, the application design is highly adaptive and modular, which means that an operator may easily create additional functional modules for the application.

A plug-in module may be embodied as any additional functionality. One example of a plug-in is the scheduler plug-in, allowing an operation to schedule actions from a common clock or calendar event. The scheduler plug-in may act as a trigger to pre-defined modules in the system at a specific time, as well as trigger to an auditor to reset and close out an event. Third party software and hardware modules may include the use of “Intelligent buttons”, which allow the operator to program and control technologies outside of their direct physical control. This includes but is not limited to other technologies on-site such as lighting controls, SCALA systems (an advertising system known as Info-Channel produced by Scala Inc., 1801 Robert Fulton Drive, Suite 400, Reston, Va. 22091, allows advertisement pages with text and illustrations to be transmitted from a control center to a network of television sets), sound systems, water cannons, etc. Intelligent buttons may be directly connected to the Main/Sub-Server architecture via the Data Transport Protocol. In one embodiment, a button programmed on the Main Server may completely synchronize a set of operations over a hundred devices. This ability to use one button to synchronize many different display devices and real world physical items such as stage lights is unique.

The customization module permits an operator to customize the look and feel of the VUI, hotkeys, or buttons in either single click mode, double click or drag and drop, a plurality of options to customize buttons to help operator to organize their layout to their needs. The configuration module may allow an operator to support incoming serial data streams, allowing for display of scoreboard and out-of-town scores on LED fascia panels.

The playback module may include functionality such as an advanced high resolution and high color depth media playback engine, support for external graphical overlay that can be used with third-party software, On-Demand and Playback-Queue based control of the external overlay, real-time auditing of the media with visual feedback and automatic game period detection, customization of auditing to different sports and other events, on-demand preview of media within system, run-time media verification and automated instant failure recovery, drag and drop interface for organization of media queues and their playback, intelligent buttons (actions) that offer custom/automated queuing of content, keyboard mappings to any user interface element including intelligent buttons, and asynchronous operation of the user interface without an impact on the Render Engine. In other embodiments the playback module may also include, singly or in combination, functional modules giving an operator the ability to render animations (computer graphics) on display devices via intelligent scriptable buttons. And the playback module may include clip verification software to verify content is good before an event import and to playback a wide variety of graphic file formats with raw uncompressed content as well as compressed content; PCG-real time scrolls, crawls, multi-layered elements and statistics, detect improper shutdown through a quick recovery mode; audit in real time creating real time statistics of elements that have run, how long, from where, and even can tell the operator which clips still have time to run and which ones do not need to run.

Again, the preceding embodiments serve only as an example of the some of the functionality and should not be read to limit the present invention in any way. The modular and adaptive software design permits the addition of many more functional modules. Any of the functionality mentioned above may be added, accessed, implemented, stopped and even removed from the application layer via the presentation layer.

### Presentation Layer

The presentation layer is responsible for the presenting a VUI representing the system or systems described above in a visually intuitive way to the operator. Functionally, the VUI is the aggregate of the means by which an operator interacts with the Main Server, Sub-Servers, networked hardware devices, and the display device. An operator provides input by manipulating the VUI's interface objects and their elements. The application then activates or triggers functions based on the operator's manipulations by sending a signal to a device on the network. It should be apparent to those having skill in the art that the VUI provides a new layer of abstraction between computing, storage and networking hardware, and the application modules running underneath it. Indeed, the most novel aspect of the present invention is the employment of a VUI to manage and control a real-world device.

In accordance with the current invention, a VUI may be understood as being a three-dimensional, immersive environment having a plurality of interface objects, tools, and modes available within the virtual environment. Interface objects may take the standard form of the windows-based GUIs, having the same de facto attributes, but the VUI is not necessarily so limited. The interface objects may also be embodied as a combination of window-based interfaces, command line interfaces, tactile interfaces, zooming interfaces (where interface objects may be represented at different levels of scale and detail, and where the operator can change the scale of the viewed area in order to show more detail), gesture based interfaces and the like. Each interface object may have within it a set of interface elements.

The interface elements may include the standard windows-based GUI elements (e.g. forms, menus, tabs, buttons, icons, folders, scrolls, toggles, and the like). In some embodiments, interface elements may also include trees, graphs, diagrams, treemaps, node-link and other data visualization forms. One novel aspect about the VUI is that a plurality of interface objects may be simultaneously presented within the single virtual environment. The VUI may also include a plurality of interface tools for navigating the space. These tools include, but not limited to, fish-eye menus, transition-based discs, menu bars, tabs, and network diagrams. The operator may also place the VUI in a mode, a distinct method of operation within the VUI, in which the same input can produce different results depending on the mode of the VUI.

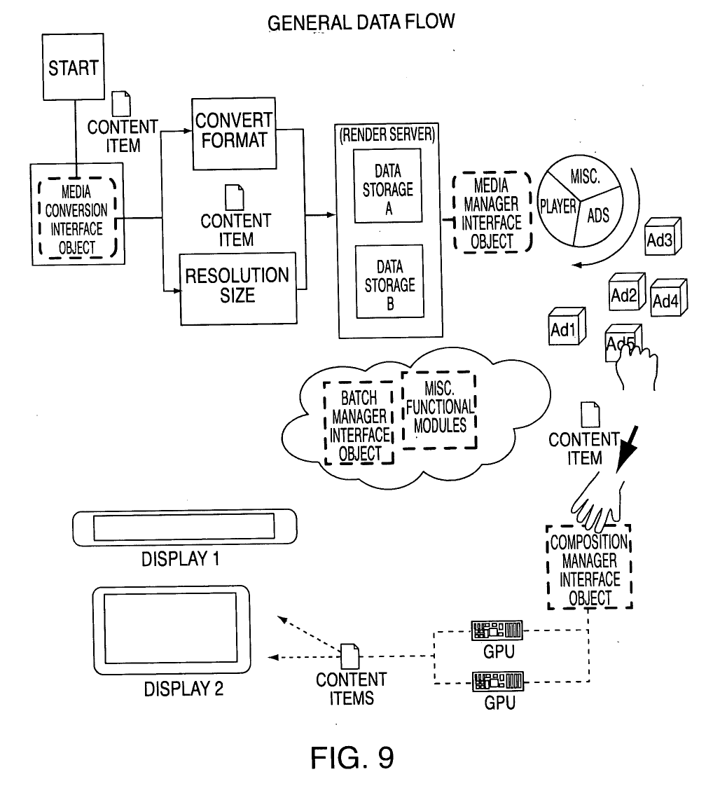

Turning now to FIG. 9, we see a flowchart for a routine operation involving the sending of a media file or content item to a display device. To demonstrate how an operator may interact with the VUI, we will follow the steps provided in the flowchart. It is important to note that the flowchart is merely one example of how an operator may interact with the VUI. It will be apparent to those having skill in the art that there are many different ways of accomplishing the same task.

One may look at the flowchart in FIG. 9 as having a discrete number of steps. Those steps include media conversion, media storage, display selection, media organization, composition management, image layering, and batch creation. As shown in FIG. 9, the first step is media conversion. To convert media into a format that a display device will be able to render, the VUI may present a media converter Interface Object (IO). In one embodiment, the media converter IO is a standard windows-based form having a field and button for entering the location of a media file, a field and button for entering the location of the output file, two override buttons enabling an operator to choose a conversion algorithm, two file format buttons for images and video respectively, and a convert button.

When an operator chooses a file for conversion, the media converter IO will present a dialogue box asking where the media file is to be stored. After conversion, the operator may store the media file on the computer readable medium of a Render Server. In one embodiment, the media files are stored according to a category and display length. Once the media file is stored, an operator may then select a display device.

A display device may be selected, brought to the foreground, in a number of different ways. An operator may select the display from the menu display in the menu bar. In addition, an operator may select a display by a double-clicking the composition manager interface object for that display. An operator may also use the customized keys to select a display. For example, in one embodiment having two displays, pressing the number “1” key selects the first display while pressing the number “2” key selects the second display.

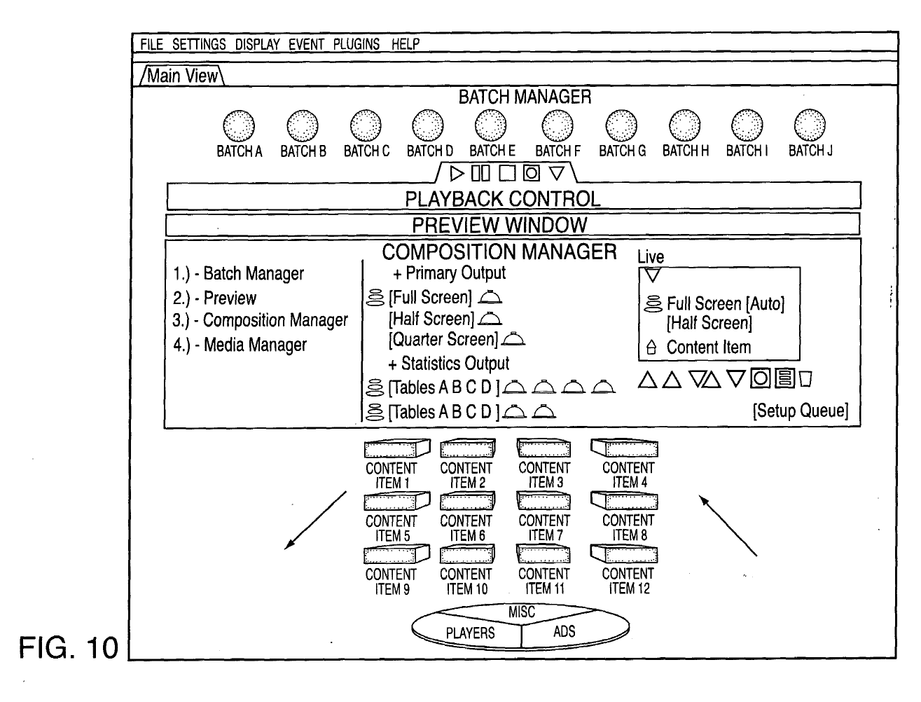

When a display is selected, the media manager IO for that display is also presented. In one embodiment, the media manager appears at the bottom of the VUI. The media manager interface object has at least one graphical object item representing the organization of media files (content items) and a plurality of graphical interface elements representing the files. As shown in FIG. 10, a three-dimensional disc or pie represents the different categories of media. The customizable categories are delineated by color and described by a text description overlay. The pie or disc embodiment represents the hierarchy of the media files. When a category is selected, the media files are presented as three-dimensional blocks around the disc, preferably in substantially an arc arrangement about the disc.

The three-dimensional blocks may be presented on the monitor with thumbnail images associated with their respective data. For example, the blocks in the advertisements category may be presented with the brand, logo, or mark of the advertiser. The next step, organizing media files, may be accomplished through the media manager IO. The media manager IO allows an operator to add and rename categories or files, move files via drag and drop, perform a transition or rescan the media by activating the Rescan item in the menu bar.

Turning to the VUI screenshot of FIG. 10, there are three rows of media files displayed on the media manager IO. As more media files are added it may be helpful to increase the number of rows so that more media files may be presented at the same time. This may be accomplished by selecting the Settings menu item on the menu bar 805 and by using a form to customize the number of rows.

When an operator performs a mouse-click on a category, the VUI responds with a transition effect. In this embodiment the media manager IO has a disc with three categories. The categories are Miscellaneous, Advertisements and Prompts. By right-clicking on any of the three categories on the media manager disc, the operator can change the set of blocks (media files) presented. As the category is mouse-clicked (activated or triggered), the media files transition about the category disc. For example, media files associated with the triggered category may rotate about the disk. There are many ways of transitioning interface elements, such as dissolve, fade, slide, pop, and bounce, that will be apparent to those having skill in the art. Rotating three-dimensional blocks about a disk is merely one illustration.

Without limitation, there are many different ways to visualize data. Any geometric or even irregular shape or color may be used to represent how media files are organized. In addition, network diagrams, treemaps, trees, graphs may be used represent the hierarchy of the data in other embodiments. An operator may customize and configure how the VUI represents this information through various controls in the menu bar, plug-in modules or third-party applications.

When the appropriate media files are presented, an operator may perform the next step by dragging the media files to the composition manager interface object. As shown in FIG. 10, the composition manager interface object 803, a zooming interface, gives the impression to the operator of being at a distance from the media manager interface object. The composition manager interface object 803 may be enlarged or brought to the foreground by pressing the number “2” on the keyboard or by double-clicking (activating or triggering) the composition manager interface object. The size and location of the composition manager interface object may be changed by left-clicking and holding the mouse on the compass icon in the middle of the interface. Once selected, the interface may be moved anywhere on the screen along the x and y axis until the mouse button is released. If right-clicked and held, the composition manager interface object will move along the z-axis by becoming larger or smaller with mouse movement until released.

This “zooming interface” of the composition manager provides the operator with a novel control with respect to how multiple display devices are managed and controlled. As we see in FIG. 8, the composition manager has five distinct interface elements. These interface elements may include a video output list element, a statistics input element, a setup queue list element, a live queue list element, and a set of control buttons element.

As shown in FIG. 10, the video output list element may be seen in the middle of the composition manager interface object. As mentioned above, the composition manager interface object is associated with a particular display. The video output list element may list the different file lengths that the display device will accept. On the right of each video output is a bell icon. The bell is a physical representation of the video output. A full size bell image represents the file lengths equal to the full length of the display device. A half-size bell image (not shown) would represent the file lengths equal to one-half of the full length of the display device. The bell icon may act as an error checking module by indicating that the file selected matches the length of the video display. For example, when an operator drags a full length file to the video output, the full length video output bell icon turns green while incorrect video output lengths turn the bell icon red. Other color coding systems may be employed. Once a file is placed in the video output list element, it is automatically presented in the Setup queue list element.

The statistics queue list element is located below the video output list element. This is where an operator may control items such as out-of-town scores, birthday names, lottery results and the like. The statistics data resides on a Statistics Server that is in communication with the Main Server. The operator may interact with the Statistics Server through the Statuslink interface object, embodied as a window with tab elements. The tabs may hold a plurality of tab elements for encapsulating functionality. The preferred embodiment has four tabs including a Scores Monitor Tab, Statistics Exporter, Baseball League, and ProStats Tab. The tabs contain interface elements for exporting, importing, connectivity, and other functions presented as buttons. As shown in FIG. 10 as stacked circle icons of descending area, by clicking on one of these icons in the statistics queue element, the operator places the statistics data in the setup queue list element of the composition manager interface object.

The Setup queue list element is a workspace that is intended for creation of multiple layer configurations and media playlists. This interface element may be used as a staging/preparation area for creation of compositions that can then be displayed on the target display. The Live Queue element is a non-modifiable workspace that represents files that are currently playing on the display, essentially making the Setup Queue the last stop for files before they are displayed in the Live Queue.

The “set of control buttons” element allows an operator to effectively mange the content being sent to a display device. A color-coded (here red-colored) triangular-shaped button brings all of the content items in the Setup Queue to the Live Queue, replacing any files that may have been in the Live Queue. The single, upwards pointing, yellow triangle button brings all files from the Setup Queue to the Live Queue, adding them to the contents of the Live Queue, but keeping intact the files that were already occupying the Live Queue. The dual, (here yellow) triangular buttons (pointing up and down respectively) is a “swap” key. Upon activation of the swap key (mouse-click), the content items in the Live Queue and in the Setup Queue are swapped. The single, downward pointing, yellow triangular button takes all of the content items in the Live Queue and moves them down, adding them to any other files occupying the Setup Queue. The (here red) square button with a hole in the center immediately clears the Setup Queue when activated. The red square button of FIG. 10 encapsulating the three small rectangles will immediately clear all of the content items in the Live Queue and in the Setup Queue upon activation. In some embodiments, an operator might notice a small arrow button appear next to the name of the video output list element, pointing up in the Setup Queue and down in the Live Queue when content items are placed in the Setup Queue or the Live Queue. The small arrow button moves what is located in a video output list element from queue to queue. The last control button in the composition manager interface object is the garbage can button located at the end of the line in FIG. 10. The garbage can button may be used to remove files from the Setup Queue by dragging and dropping the files into the garbage can. With an understanding of how an operator may use the composition manager, it is now logical to discuss one of the more advanced functions of the invention, layering.

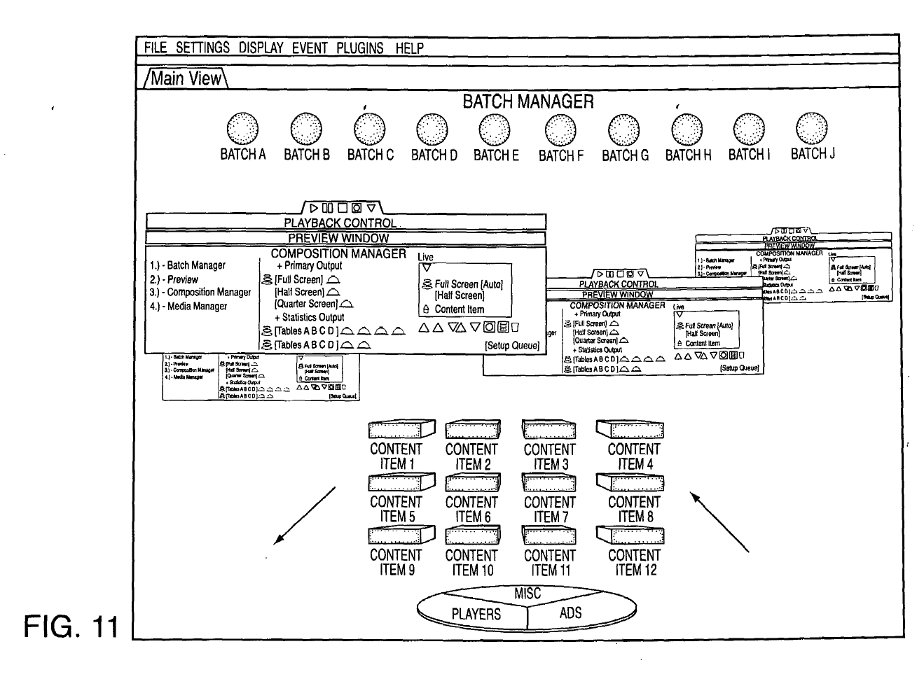

Turning to FIG. 11, we can see how the process of layering may be accomplished. Layering consists of bringing content items of different output lengths together to be sent by a video output list element to the display device at the same time. In other words, the VUI allows an operator to break up a single display device into layers. A first layer may be prepared by dragging a file or files to a first video output list element; this places that file into the Setup Queue of that display. A second layer may be added by dragging and dropping files to a second video output list element.

To add yet another layer, an operator may simply drag and drop another file into another video output list element. The file will then be placed in the corresponding Setup Queue next to the video output list element. Now, when the Setup Queue is sent to the Live Queue, both outputs will be sent out, each filling their designated spaces and leaving no blank spots on the display device. Statistics layers may act just as other layers. An operator may add a statistics layer, (i.e. Birthday, Lottery, Congratulations) by activating the stacked circle icon next to a target layer. Right-clicking places the statistics in the Setup Queue. When an operator creates a layer the interface provides a lock icon at the top right of the target video output list element. When the operator activates the lock icon, operator interaction with the control button elements will not move the layer. The single arrow button will, however, move a locked layer either up or down when activated.

The last step in the flowchart in FIG. 9 is the create batch step. A batch may be embodied as a macro, a set of saved key strokes or mouse gestures. A batch may be created for any of the functionality available to an operator. Turning to FIG. 11, the batch manager interface object is located above the preview interface(s). An operator may interact with the batch manager interface object to create, capture and edit batches. In the preferred embodiment, the batch manager presents an options pane as a set of text buttons located at the top of the VUI. The text buttons in the options pane may include a create batch button, a live queue capture button, a setup queue capture button, a properties button, a delete button, a reset button, an exit button, and a clear contents button. Other embodiments may include more text buttons in the options pane.

When a batch is created in the options pane, the “batch action properties interface element”, a dialogue box, is presented to the operator. Included in the properties dialogue box is a keyword field and keyword button element. A keyword is a feature that allows for a batch keyword on a first Main Server to be associated with a batch keyword on a second Main Server. When an operator runs a batch by activating a keyword, other Main Servers will activate their own batch associated with the same keyword. After the batch is created with properties, an operator may add, remove, relocate content items within a batch. An operator may also reorder and label batches. All of the preceding functionality may be accomplished with input from a mouse.

As batches are added, batch icons appear underneath the options pane element. When the number of batch icons increases significantly, the VUI may become crowded. Like the media manager interface object, the operator may transition the existing batches by sliding them along the y-axis. The VUI also provides a menu item for customizing the number of rows displaying batch icons.

FIG. 10 shows the first screenshot of the VUI. It is important to note that the media manager interface object does not need to be represented. Without limitation, any of the interface objects may be hidden from the operator by changing a setting in the display menu in the menu bar. To compare, FIG. 11 presents a plurality of composition manager interface objects, one per display device. It should be apparent to those having skill in the art that having a plurality of composition manager interface objects on a single monitor allows an operator to simultaneously work on the playlist, setup queue or live queue for every display device.

In addition, FIG. 11 illustrates the unique capacity of the VUI by presenting a real-time preview strip of the content playing on every display device. The preview mode may also be configured to provide a preliminary playback for quality assurance of the content items in the setup queue.

The preview mode is possible because of the unique combination of isolating graphics processing operations, strong graphics algorithms, and because of the Main Server/Sub-Server architecture. Because images are stored and transmitted in a non-segmented manner, it allows the system to utilize the rendered image for preview in the VUI. Since the content items may be stored on the Render Servers, the processing for previewing these images does not affect the performance of the Main Server. Therefore, the VUI is able to present real-time three-dimensional previews of what is playing on the display devices, even for a large number of display devices. This is very helpful especially when the actual display device is obscured, obstructed or otherwise outside of the operator's view.

Without limitation, the VUI display scheme is highly customizable. An operator may adjust the transparency, brightness, translucency, size, spatial positions of interface objects and their elements. The VUI also affords the operator a broad range of configuration options for optimizing hardware, network and ultimately playback performance.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A system for operating a real world device unit, comprising:
a three-dimensional virtual user interface, the three-dimensional virtual user interface having a plurality of interface objects, the interface objects having a plurality of interface elements;
a status interface object for monitoring an attribute of the real world device unit;
a control interface object for activating a function of the real world device unit;
a link for transmitting a first signal to the real world device unit and receiving a second signal from the real world device unit;
the first signal communicating an instruction to perform the function activated by the control interface object;
the second signal communicating a status of the attribute monitored by the status interface object.

2. The system for operating the real world device of claim 1, wherein the real world device unit is a display device.

3. The system for operating the real world device of claim 1, wherein the real world device unit is comprised of a plurality of real-world devices.

4. The system for operating the real world device of claim 1, wherein the real world device is a lighting control device.

5. The system for operating the real world device of claim 1, wherein the real world device is a sound system device.

6. The system for operating the real world device of claim 1, wherein the real world device is a water cannon.

7. The system for operating the real world device of claim 1, wherein the real world device is a fireworks device.

8. A system for operating a display device, comprising:
a three-dimensional virtual user interface, the three-dimensional virtual user interface having a plurality of interface objects, the interface objects having a plurality of interface elements;
a media manager interface object for managing a plurality of content items;
a composition manager interface object for rendering a content item on the display device.

9. The system for operating the display device of claim 8, further comprising:
a batch manager interface object for creating, editing, and running a batch.

10. The system for operating the display device of claim 8, further comprising:
a preview interface object for previewing in real-time the content item being rendered on the display device.

11. The system for operating the display device of claim 8, further comprising:
a menu bar for customizing a layout scheme of the three-dimensional virtual user interface and configuring a set of system options.

12. The system for operating the display device of claim 8, further comprising:
a statistics manager interface object for importing and exporting a set of statistics data, the imported set of statistics data being available for sending to the display device from the composition manager interface object.

13. The system for operating the display device of claim 8, wherein the media manager interface object is a data visualization tool comprising a customizable graphical disc element and a set of customizable graphical block elements, the customizable graphical disc element for categorizing the plurality of content items, the set of customizable graphical block elements representing the plurality of content items arranged substantially in an arc about the customizable graphical disc element.

14. The system for operating the display device of claim 8, wherein the composition manager interface object comprises:
a video output list element being operable to receive the plurality of content items from the media manager interface object;
a statistics list element representing a set of statistics data;
a setup queue list element for preparing a setup queue with the plurality of content items from the video output list element and the statistics list element;
a live queue list element representing a list of content items playing on the display device; and
a set of control buttons for editing the plurality of content items in the setup queue list element and in the live queue list element.

15. The system for operating the display device of claim 8, wherein the composition manager interface object is a zooming interface, the zooming interface being movable along an x-axis, a y-axis and a z-axis.

16. The system for operating the display device of claim 8, further comprising:
a second display device;
the composition manager interface object being associated with the display device;
a second composition manager interface object being associated with the second display device; and
a first and a second preview interface object being associated with the display device and the second display device respectively, the first and the second preview interface objects for previewing in real-time the content item being rendered on the display device and for previewing in real-time a second content item being rendered on the second display device.

17. A method for operating a display device, comprising the steps of:
presenting a three-dimensional virtual user interface, the three-dimensional virtual user interface having a plurality of interface objects, the interface objects having a plurality of interface elements;
using a media manager interface object to manage a plurality of content items;
rendering a content item on the display device by performing the step of importing the content item from the media manager interface object to a composition manager interface object.

18. The method for operating the display device of claim 17, further comprising the steps of:
creating a batch script for sending a set of content items from the media manager interface object to the composition manager interface object, the batch script created in a batch manager interface object, and
running the batch script by activating a run batch button element in the batch manager interface object.

19. The method for operating the display device of claim 17, further comprising the steps of:
customizing a layout scheme of the three-dimensional virtual user interface by changing a first setting element in a menu bar interface object; and
configuring a set of system options element in the menu bar interface object by changing a second setting element.

20. The method for operating the display device of claim 17, further comprising the steps of:
importing a set of statistics data by interacting with a statistics manager through an input device, the input device comprising a keyboard and a mouse;
placing the set of statistics data into a setup queue list element in the composition manager interface object, and
moving the set of statistics data to a live queue list element in the composition manager interface object by activating a control button element in the composition manager interface object.

21. The method for operating the display device of claim 17, further comprising the steps of:
presenting the media manager object interface as a data visualization tool, the data visualization tool having a graphical disc divided into at least three categories and a set of three-dimensional blocks representing content items;
arranging the three-dimensional blocks substantially in the form of an arc about the graphical disc;
selecting a category of the graphical disc
presenting a selected set of three-dimensional blocks, and
transitioning the selected set of three-dimensional blocks by rotating the three-dimensional blocks about the graphical disc.

22. The method for operating the display device of claim 17, further comprising the steps of:
selecting the display device by bringing the composition manager interface to the foreground of the three-dimensional virtual user interface;
dragging and dropping a first three-dimensional block from the media manager interface object to a video output list element in the composition manager interface object;
representing set of statistics data as a statistics list element in the composition manager interface object;
moving the first three-dimensional block from the video output list element to a setup queue list element;
moving the first three-dimensional block from the setup queue list element to the live queue list element by activating a control button in the composition manager interface object; and
previewing in real-time the rendered content item on the display device in a live queue list element.

23. The method for operating the display device of claim 17, further comprising the steps of:
positioning the composition manager interface object about an x-axis, a y-axis or a z-axis of the three-dimensional virtual user interface.

24. The method for operating the display device of claim 17, further comprising the steps of:
presenting a preview interface object in the three-dimensional visual user interface, the preview interface object being a graphical representation of the display device, and
playing, in real-time, the rendered content item in the preview interface object.

25. A computer system for operating a display device, comprising:
a monitor for presenting a three-dimensional virtual user interface, the three-dimensional virtual user interface for operating a display device;
an input device for sending an input signal to the virtual user interface, the input device in communication with the monitor;
a processor for processing the input signal from the input device, the processor in communication with a network link;
the network link for transmitting the processed input signal from the processor to the display device.

26. The computer system for operating the display device of claim 25, further comprising:
a computer readable medium for storing a plurality of content items, the plurality of content items being directed to the display device by the processed input signal.

27. The computer system for operating the display device of claim 25, wherein the monitor is comprised of a plurality of computer monitors.

28. The computer system for operating the display device of claim 25, wherein the input device comprises a keyboard and a mouse.

29. The computer system for operating the display device of claim 25, wherein the input device comprises a camera and a microphone.

30. The computer system for operating the display device of claim 25, further comprising a graphics processing unit.

31. A computer system for operating a plurality of display devices, comprising:
a main server having a computer monitor for presenting a three-dimensional virtual user interface;
the main server sending a first and a second set of graphics operations to a sub-server; the sub-server in communication with a graphics processing unit for processing the first and second sets of graphics operations;
the graphics processing unit being operably connected to a first and a second display device for rendering a first content item and a second content item on the first and the second display devices respectively.

32. The computer system for operating the plurality of display devices of claim 31, further comprising:
a backup sub-server, the backup sub-server in communication with the main server and the sub-server;
a statistics sub-server, the statistics sub-server in communication with the main server and at least one display device;
a render sub-server, the render sub-server in communication with the main server and with the at least one display device.

33. The computer system for operating the plurality of display devices of claim 31, wherein the statistics sub-server is a database.

34. The computer system for operating the plurality of display devices of claim 31, wherein the computer monitor of the main server comprises a plurality of monitors for presenting the three-dimensional virtual user interface.

35. The computer system for operating the plurality of display devices of claim 31, wherein the input device comprises a keyboard and a mouse.

36. The computer system for operating the plurality of display devices of claim 31, wherein the input device comprises a camera and a microphone.

37. The computer system for operating the plurality of display devices of claim 31, wherein the sub-server is a dedicated sub-server, the dedicated sub-server being dedicated to one display device.
